(19) United States
(12) Patent Application Publication
(10) Pub. No.: US 2005/0018417 A1
(43) Pub. Date: Jan. 27, 2005

(54) Flexible LED light kits for footwear

(76) Inventor: Tseng-Lu Chien, Taipei Hseng (TW)

Correspondence Address: BACON & THOMAS, PLLC, 625 SLATERS LANE, FOURTH FLOOR, ALEXANDRIA, VA, 22314, US

(21) Appl. No.: 10/883,741

(22) Filed: Jul. 6, 2004

Related U.S. Application Data
(63) Continuation-in-part of application No. 10/170,584, filed on Jun. 14, 2002, now abandoned.
(63) Continuation-in-part of application No. 10/285,451, filed on Nov. 1, 2002.
(63) Continuation-in-part of application No. 10/286,820, filed on Nov. 4, 2002.

(51) Int. Cl. F21V 21/08

(52) U.S. Cl. 362/103

(57) ABSTRACT

The current invention mainly for a flexible LED light for footwear consist of a flexible and bendable printing circuit board (hereafter as FPC) incorporated with model super compact LED which in a form of dice and chip and some sealing material with conventional sealing procedure to become a super brightness, compact size, and having the excellent cosmetic appearance. Further improvement to apply a press sensitive switch to trigger the integrated circuit to prevent from the delivery power consumption of limited power of the batteries which may connected by any combination in-series and in-parallels to get different voltage and amperage to drive the different color LEDs to get the best light effects and functions.

This application is a continuation-in-part of U.S. patent application Ser. No. 10/170,584, filed Jun. 14, 2002 and Ser. No. 10/285,451, filed Nov. 4, 2002 and Ser. No. 10/286,820, filed Nov. 4, 2002.

### BACKGROUND OF THE INVENTION

The current invention relates to apply the Flexible Printing Circuit (hereafter as FPC) as a basic substrate material to install the dice or chip of LED element by bonding technical.

The Flexible Printing Circuit (FPC) having the features for bending, flexible, durable so can let the LED(s) well install on these copper area(s). The dice or the Chips of LED having the super compact dimension so allow people can have the super narrow and flexible LED(s) panel such as the Dice can have dimension less than 3 mm and Chips also less than 7 mm so can have super narrow LED(s) Band or Board for variety application which can not do before.

The Current invention applied the marketing place available LED dice or chip applied to the FPC to create the flexible, bendable, durable LED(s) light kits incorporated with Integrated circuit and push on-off switch by weight to trigger the Integrated Circuit (hereafter as IC) for footwear which will prevent from the delivery battery power consumption which is major problem for prior art of the Mr. Nick Rogers and Mr. Wei. Both of the prior arts, the trigger by the vibration switch and the Integrated Circuit will be start to functions while the switch from away from the contact-position or while the switch touch the contact-position. After the triggered, the light functions will last for a period of time as pre-determined time. The current invention make big improvement from those prior arts basing on the Push on-off switch triggered IC by weight and stop while the weight is away from the push on-off switch instantly.

Also, the current invention with special batteries arrangement for different voltage and amperage required by different colors LED(s). The co-inventor's prior art U.S. Pat. No. 5,599,088 disclosure polarity of batteries with combination of selection of connecting arrangement for desired voltage and amperage from in-series and in-parallel arrangement batteries.

Furthermore, the current invention teaching a weather protection for the flexible printing circuit board by injection process or by envelope process to make the cosmetic appearance so the dice or chip of LED(s) will not see by the viewers. Only the super bright and attractive motion light effects been seen from viewers.

### BRIEF DESCRIPTION OF THE DRAWINGS

FIG. 1: Disclosure the 1^{st} embodiment for a beach sandal with preferred flexible LED(s) light kits which incorporating the envelope-process to sealed the polarity of LED(s) within with eye-catching texture on the surface of the envelope.

FIG. 2: Disclosure the 2nd embodiment disclosure the Flexible LED(s) light kits with the star shape with the polarity of LED(s) on the surface and the unit with the clear plastic to sealed with build-in integrated circuit (hereafter as IC) to drive the LED(s). The push on and off switch connected between the IC and power source to make the circuit with power or cut-off the power.

FIG. 3: Disclosure the bending, flexible features of the FIG. (2) embodiment.

FIG. 4: Disclosure the FIG. (1) light kits with details components with the hot sealing envelope to seal the flexible printing circuit board with dice or chip LED(s) on it and the circuit system.

FIG. 5: Disclosure the FIG. (4) for the chip LED(s) and Dice LED(s) different dimension and arrangement.

FIG. 6: Disclosure the alternative sealing process which is co-pending filing for double injection sealing the EL panels which the sires Number are U.S. Ser. No. 10/621,513.

FIG. 7: Disclosure the alternative sealing process which is use the plastic compound may selected from the group of compound selected from the silicone, soft PVC, PVC sheet, PE sheet, PU sheet or the other conventional available soft plastic material for sealing procedure.

### DETAILED DESCRIPTION OF THE PREFERRED EMBODIMENTS

The current invention has the several technical to create the best LED(s) light kits for Footwear applications. The basic technical including (1) Flexible printing circuit board (2) Dice or Chip type of LED(s) (3) Integrated circuit for LED(s) preferred functions with trigger means by push on and off switch controlled by the weight applied to the said switch(4) Proper sealing means applied to seal the FPC and LED(s) to make good appearance and cosmetic value (5) super narrow and compact size for the light unit (6) Sealing means and process for the most efficient for environment concern and durable quality.

The US prior art including Roger's U.S. Pat. No. 4,848,009, U.S. Pat. No. 5,343,190 , and Weng's U.S. Pat. No. 5,663,614 , and Wei's U.S. Pat. No. 6,525,487, and Anterby's U.S. Pat. No. 6,280,045, U.S. Pat. No. 6,354,712 and Wut's U.S. Pat. No. 6,104,140, U.S. Pat. No. 5,909,088, U.S. Pat. No. 5,866,987 and Goldston's U.S. Pat. No. 5,303,485, U.S. Pat. No. 5,546,681 and other prior arts including the U.S. Pat. Nos. 5,033,212, 5,329,432, 5,394,312, 5,371,662, 5,438,488, 5,456,032, 5,457,900 did not apply the dice or chip size LED(s) on the flexible Printing circuit or did not incorporated with the current invention for push on and off switch to trigger the IC to create the light functions. The prior art have bulky traditional LED lacking of the flexible printing circuit board (or the equivalent function basic substrate).

The motion switch also created the power consumption during the delivery process to cause the power wasted. The current invention made big improvement for all those prior arts.

Basing on these features can created the best flexible LED(s) light kits for footwear application as follow introduction details features with details description:

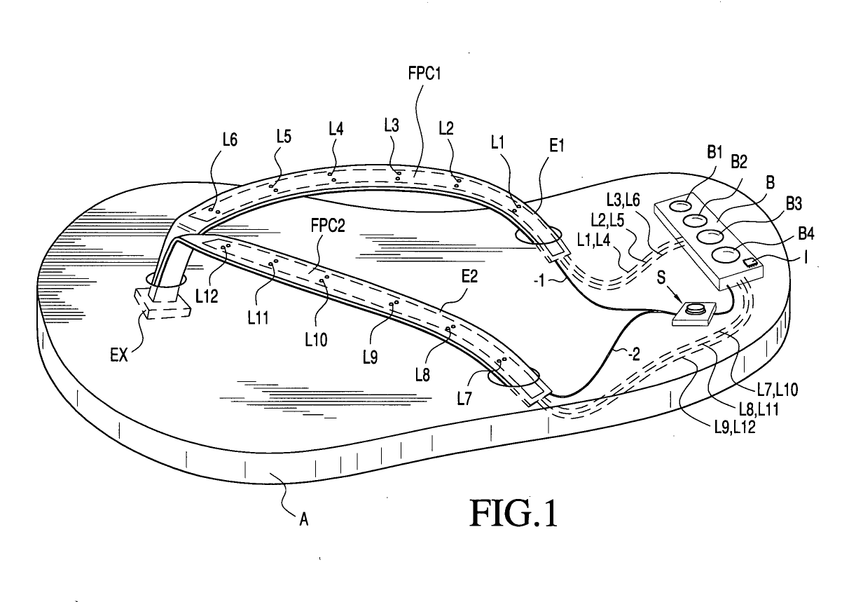

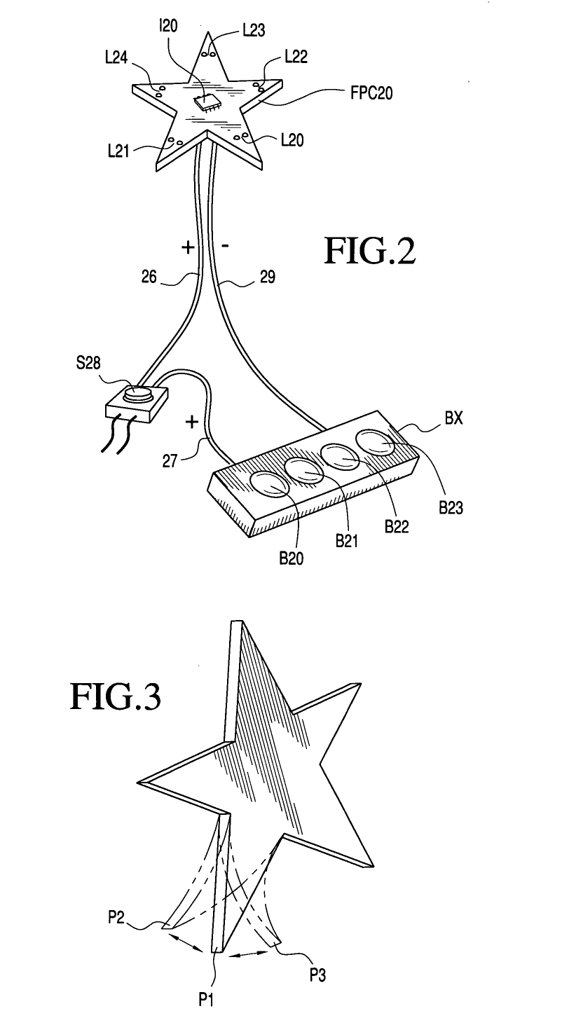

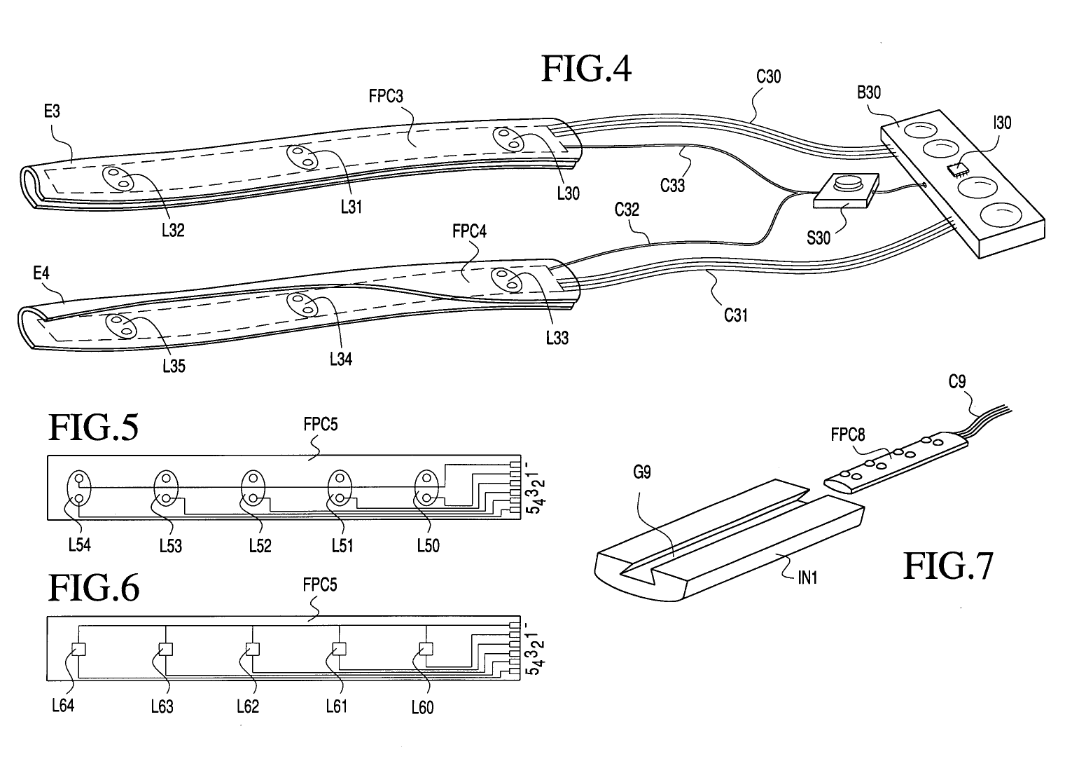

(1) Flexible printing circuit board of the modem technical, the each conductive trace may design as narrow as possible for some applications. The trace width are less than the 0.1 mm incorporated with the dice type of LED will create the very narrow space needed for certain applications. For example the FIG. 1 the each lighted LED of the dice type plus the several conductive traces for each LED only less than 3.5 mm. Because the dice type of LED including the chemical sealing will not bigger than 0.5 mm to 2.0 mm. The chip type of LED with its sealing of the standard unit, the dimension only approximately 1.5 mm×2.0 mm. Hence, the conventional technical apply to the current inventor's prior art U.S. Pat. No. 5,722,757 will have big improvement by the new type of LED been available at market place.

(2) The integrated circuit (hereafter as IC) incorporated with the press sensitive switch which may select from the group models from market place. This combination for the IC and the press sensitive switch can prevent from the power consumption during the delivery by truck, boat, and airplane. The earlier prior arts mainly to use a spring vibration switch which will have difficult to well control the trigger circuit and let the battery power into light consumption during the delivery. It also will have big potential the spring for orientation precisely so the current invention preferred to use the press sensitive switch which can have different specification such as the switch will not connect together if the weight is no heavy than 30 kilograms (66 lbs) to prevent from the sitting still have the power consumption happen.

The Alternative switch may consideration or the multiple piece of switch can incorporated with the press sensitive switch.

It also can have the IC control while the Press Sensitive switch been connected for over period of time, then, the IC will turn off the circuit and wait for next time weight apply to the press sensitive switch so this will not have problem while the current invention do not use the vibration switch and the IC been control by the vibration switch contact-point as Nick's '009, and Wei's '487 and Weng's '614 prior arts.

From FIG. 1, disclosure the 1^{st} embodiment for a beach sandal with two flexible LED(s) light within a outside envelope (E1) (E2) which are made by preferred material may select from group combination of plastic, textile, metal, and any soft material so can allow the light kits for bending, flexible, twisted, and pulling.

The two pieces of the flexible printing circuit (FPC1) (FPC2) with plurality of the LED (L1)(L2)(L3)(L4)(L5)(L6) fixed on the with desired copper traces of the (FPC1) to delivery the electric signals from the circuit box (B) to the LED(s) for desired light functions and time period. The dice or chip LED(s) installation can use current inventor's earlier issued patent U.S. Pat. No. 5,746,500 arrangement for proper LED(s) installation and circuit designs with little different from the switch selection.

The LED (L1)(L2)(L3)(L4)(L5)(L6) preferred use the dice type which can fix on the (FPC1) as tiny as possible such as 0.5 mm to 2 mm diameter after the epoxy sealing. The LED(s) (L1)(L2)(L3)(L4)(L5)(L6)and all related traces will be only have less than 3.0 mm width but can have all the desired functions , brightness, colors, shape, size, dimensions, features so can apply to all kind of location for footwear. The current embodiment is for a beach sandal's upper straps. The both (FPC1) and (FPC2) have its owned the conductive means (−1)(L1+4)(L2+5)(L3−6) and (−2) (L7+10)(L8+11)(L9+12) to connected the switch means(S) and circuit means (I) which are away from the shoe upper. This embodiment preferred to install all switch means(S), circuit means (I), box means (B) inside the outsole. The batteries (B1)(B2)(B3)(B4) are well arranged inside the box(B) aside of the circuit means (I) and batteries can be connected for any combination of in-series and in-parallel as current inventor's earlier issued prior art U.S. Pat. No. 5,599,088. The desired combination for plurality of the batteries in-series and in-parallel can create a different voltage and amperage for different LED(s) specification so can get attractive light effects with rich colors.

The (FPC1) are sealed by a envelope which preferred is a thin plastic sheet with excellent textile and soft material with good color and light passing though capability. The envelope can be made in tube, pipe, cylinder, and flat sheet and use marketing conventional process to put the (FPC1) within the envelope. The (FPC1) may be shorter than the outside envelope so the extra part of (E1) can be put underneath into the shoe bottom. In order to the extra part of envelope can well hold underneath, the envelope for two ends can be have extra area (EX) to fix so can pass the wearing pulling test which have to over 80 kilogram pulling strength. The material selection for the envelope can be selected from soft plastic material such as PU, PVC, PE, ABS, PC to allow the wear feel comfortable while all these chemical compound with desired softness. The texture (not shown) of the envelope (E1) (E2) can be added to meet market requirement. The sealing method of the (FPC1) (FPC2) can use hot sealing of a foldable plastic sheet. It also can seal the (FPC1) (FPC2) by injection process as co-pending filing case series no: U.S. Ser. No. 10/621,513. From FIG. (7), Show the double injection process. The 1^{st} injection plastic part (IN1) with build in groove (G9)to allow the certain width elongate (FPC9) can slide into the groove wider bottom area and narrow upper portion will stop the ( FPC9) to fall out while use the horizon injection machine. This arrangement will allow all plastic injection factories can do the injection as quickly as possible and no need to use the vertical injection machine which is expensive for labor and tooling. This embodiment is one of the examples. The 1^{st} injection part (IN1) is not limited have to with the wider bottom and narrow upper shape design. The any alternative method and design still within the scope of the current invention for injection sealing process.

From the FIG. (4), Disclosure the (FPC3) has LED (L30) (L31) (L32) fixed on it with the (E3) envelope to seal whole (FPC3). Same as the (FPC4) has LED(s) (L33) (L34) (L35) fixed on it with the (E4) envelope to sealed whole (FPC4).

The (FPC3) and (FPC4) also can sealed within a textile material such as weaving tube or envelope or textile piece with additional sealing means which may selected from group combination of stitch, hot sealing, welding, melting, solvent, glue, double side tape, hook and loop, rivet, or the other equivalent process to allow the (FPC3) (FPC4) be fix on desired location of footwear. It also can sealed as the same inventor's prior art U.S. Pat. No. 5,746,500 but only the application is not limited for shoe lace but for all kind of applications such as footwear straps, strips, band, decoration tube, or the any place of the footwear.

The material for the envelope can be selected from group combination of material including plastic, chemical compound, textile, woods, and metal in different geometric shape including sheet, tube, pipe, envelope, cylinder, elongated strip, string, band, strap, pocket, and folder in order to offer a space for FPC unit. For some applications, it not necessary to hold whole FPC unit within inside the said all kind of sealing means as above mentioned.

From the FIG. (5), Disclosure the dice type LEDs (L50) (L51) (L52) (L53) and (L54) fixed on the flexible substrate (FPC50). The each dice of LEDs have its owned terminal which can be soldered with other conductive means such as electric wires or ribbons to delivery the electric signals. This similar arrangement only need around 3.0 mm because each dice LED only need 0.5-2 mm width with extra 4-copper traces to deliver the electric signals to each LED so it can do very narrow to create a lot of application for footwear from shoe upper, bottom, lace, piping, decorative straps, band, strips and other properly arrangement.

From the FIG. (6), disclosure the chip type of LEDs (L60) (L61) (L62) (L63) (L64) fixed on the flexible Printing circuit (FPC60). The each chip of LEDs have its owned terminals (−′) (1′) (2′) (3′) (4′) (5′) to allow connect with outside conductive means.

The market available chip dimension around 1.5 mm width×2.0 mm long so the Chips LEDs need little wider than the chips type of LED. But this is still workable while we compare with epoxy sealed LED with 1 mm, 3 mm, 5 mm diameter for head and around 5-10 mm for body cylinder length.

From the FIG. (2), Disclosure the Flexible Printing Board (FPC20) with geometric shape (here is the star) and with the dice type LED(s) on the each corner of the star shape FPC (FPC20). The each LED (L20)(L21)(L22)(L23)(L24) are located on the each corner and the chip IC circuit (120) also fixed on the FPC (FPC20) instead of the other embodiment the IC circuit are install on the Circuit Box. This will offer a very good wiring arrangement as the FIG. (2) showing the two wires (+26) and (−29) come out from the FPC (FPC20). Both wires are connected with power source (BX) with plurality of batteries (B20) (B21) (B22) (B23) with combination of electric connection of in-series and in-parallel to get desired voltage and amperage to drive different LED units. The Wire (+26) connected with one press sensitive switch (S28) and come out of wire (+27) so can use the press sensitive switch (S28) to make the power been connected or disconnected. The press sensitive can be designed to make connection while the weight is over fixed number, too light weight will not make the electric connection as above mentioned and discussion.

From FIG. (3) can see the Flexible Printing Circuit Board can be bended from position (P1) to backward to position (P2) or to forward to position (P1). The sealing material and process of this star shape flexible printing circuit board as earlier discussed and mentioned.

Although, above preferred embodiments of the invention have been described in details. It will be appreciated that the scope of the invention is not to be limited to the described embodiments, but rather that the invention is to be interpreted in accordance with the appended claims.

1. A Flexible LED light kits for footwear incorporated:
At least one basic substrate which is flexible material to offer a surface to install the said dice or chip type LED(s) with desired spacing and width on the surface with pre-designed conductive traces to deliver the electric signals to each of said LED for desired light functions and time period under pre-determined features.
At least one of circuit means to supply electric signals to LED(s) for desired functions and light effects and duration which triggered by the press sensitive switch by certain weight applied top of the said switch.
At least one of sealing material to seal the said basic substrate within, the said material may selected from group combination of plastic, chemical compound, textile, wood, metal in desired geometric shape incorporating with conventional sealing procedure may including of stitch, hot sealing, solvent, glue, double side tape, hook and loop, staple, rivet, melt, ultrasonic to allow the said basic substrate with LED(s) well be protected.
At least one of the conductive means to delivery the electric signals from the power source to the light means.
At least one of the power sources to offer the power the circuit means to make the circuit can be operated as desired functions incorporated the desired integrated circuit and batteries.
At least one fix means to install the said light kits on any location of footwear.
The improvement wherein the batteries can be connected by group combination selected from in-series, in-parallels to allow circuit can drive the different color LED or LED(s).
Further more, the light desired function(s) may controlled by IC and the said IC is start to work while the weight is applied to the said press sensitive switch and the desired function(s) will be stop while the weight is away from the said switch. The desired functions may selected from group combination of chasing, sequential, random flashing, all flashing, fade in and out, pair flashing and marketing conventional light function(s).

2. The Flexible LED light kits for footwear as claimed in claim 1, the footwear means may is any kind of the footwear for people to wear.

3. The Flexible LED light kits for footwear as claimed in claim 1, the LED or LED(s) means may selected from group of number, shape, illumination, dimension, colors, size, sealing , connection means with conductive means for the desired the said of light means.

4. The Flexible LED light kits for footwear as claimed in claim 1, the Integrated Circuit (IC) can have any combination of conventional functions incorporated the press sensitive switch to become a trigger means to drive the circuit for light function(s).

5. The Flexible LED light kits for footwear as claimed in claim 1, the attached means may selected from the group combination of glue, solvent, chemicals, hot sealing, ultrasonic sealing, double side, tape to seal the sealing material.

6. The Flexible LED light kits for footwear as claimed in claim 1, the basic substrate for install of the tiny LEDs with all electric traces the width will less than the 8 mm.

7. The Flexible LED light kits for footwear as claimed in claim 1, the said IC may install on the basic substrate.

8. The Flexible LED light kits for footwear as claimed in claim 1, the said IC incorporating a time counting and stop the circuit's power source if the light duration time is over predetermined time period
